(19) United States
(12) Patent Application Publication
(10) Pub. No.: US 2005/0249281 A1
(43) Pub. Date: Nov. 10, 2005

(54) Multi-description coding for video delivery over networks

(76) Inventor: Hui Cheng, Bridgewater, NJ (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(21) Appl. No.: 10/939,219

(22) Filed: Sep. 10, 2004

Related U.S. Application Data
(60) Provisional application No. 60/568,454, filed on May 5, 2004.

(51) Int. Cl. H04N 7/12

(52) U.S. Cl. 375/240.12; 375/240.01

(57) ABSTRACT

A method and apparatus for reducing the number of Intra-coded pictures (I-Picture) without any quality degradation. In one embodiment, the method takes advantage of characteristics of a heterogeneous network, such as Digital Subscription Line (DSL).

### CROSS-REFERENCE TO RELATED APPLICATIONS

This application claims benefit of U.S. provisional patent application Ser. No. 60/568,454, filed May 5, 2004, which is herein incorporated by reference.

### GOVERNMENT RIGHTS IN THIS INVENTION

This invention was made with U.S. government support under contract number 70NANB3H3053. The U.S. government has certain rights in this invention.

### BACKGROUND OF THE INVENTION

The present invention relates to broadband network architectures. More particularly, in one embodiment the present invention relates to video enhanced Asymmetric Digital Subscriber Line (ADSL) network architectures. Although the present invention is described in terminology used by the DSL Forum, the present invention can be adapted to other network architectures.

In general, compared to an Access Network, a Regional Broadband Network has a larger bandwidth, hundreds of Megabits per second (Mbps) or more. For example, a core network is defined as one or more network entities inter-working together to provide the differential transport services between ATU-C and Service Providers. The core network contains an Access Node or DSL Access Multiplexer (DSLAM) and a Regional Broadband Network. The Regional Broadband Network may institute different transport protocols such as Asynchronous Transfer Mode (ATM), Frame Relay or Internet Protocol (IP). An access network has a lower average bandwidth, e.g. 1.5 Mbps. For example, an access network is defined as an ADSL access network encompassing ADSL modems at customer premises and an Access Node at a central office. The ADSL termination within the Access Node is called the ATU-C and the ADSL termination at the customer premises is called the ATU-R. Therefore, to enable video service over ADSL, hundreds of channels of video are first transmitted to all Central Offices (CO). Then, based on customer's selection, one or more channels of videos are delivered to home over the 1.5 Mbps access network.

For most existing video compression standards, video frames/fields are coded in three different ways. The first is called Intra-coded pictures (I-Pictures). I-Pictures are coded without using any temporal reference pictures and any temporal predication. Therefore, I-pictures are coded independently from other pictures and are used for channel change, random access points. The other two types are called P-Pictures and B-Pictures. P- and B-Pictures all use temporal predication, also called motion compensation, to exploit temporal redundancy and to reduce the amount of bits needed for coding these pictures. I-Pictures are coded with the least amount of bit savings. Therefore, the average normalized bit rate of I-Pictures is much higher than the average normalized bit rates of P-Pictures and B-Pictures.

In the new international video coding standard, JVT/H.264/MPEG-2 AVC, new coding modes called SI- and SP-pictures are proposed. An SP-picture is similar to a P-picture and when SP and SI are used together, the functionality of an I-picture can be achieved. SP-pictures are not as efficient as P-pictures, and SI-plus SP-pictures are less efficient than I-pictures. However, SI/SP based switching guarantees a perfect match and does not generate drifting.

Therefore, there is a need to reduce the number of I-Pictures thereby reducing the bit rate of the coded video.

### SUMMARY OF THE INVENTION

In one embodiment, the present invention generally relates to a novel method and apparatus for reducing the number of Intra-coded pictures (I-Picture, or SI-Picture) without any quality degradation. The method, called multi-description video coding, takes advantage of characteristics of a heterogeneous network, e.g. Digital Subscription Line (DSL), and codes each I-Picture candidate twice, one using I-Picture type and one using P- or B-Picture type. An I-Picture can also be coded using both SI (Switching I-Picture) and SP (Switching P-Picture) to eliminate drift with slightly reduced coding efficiency. The I-Picture type (or SI) will only be selected for the final transmission to home (e.g. selected by DSLAM), for various conditions, e.g. when a channel change request is received at the central office. Therefore, in one example, there is a reduction in the number of I-Pictures from one per second or one per half second as required in some implementations to one per channel change request. Thus, a significant reduction in the transmission of I-Pictures is realized.

In one embodiment, an image sequence having a plurality of pictures is received, e.g., by a content provider. The image sequence is encoded in preparation for transmission to an access network that will service a plurality of users. At least one of the plurality of pictures is encoded as at least two coded descriptions having different picture types. For example, each picture identified as a potential I-Picture will be encoded using two different picture types, e.g. I-Picture or P-Picture. The encoded image sequence, including the at least two coded descriptions for some pictures, is forwarded downstream, e.g., to a router of an access network.

In one embodiment, a router receives the encoded image sequence and forwards only one of the at least two coded descriptions (when SI/SP is used, both descriptions are forwarded) with the encoded image sequence downstream in accordance with a predefined event. Namely, the router has the ability to forward one of two possible coded descriptions (or both coded descriptions in certain situations) to a receiver that is downstream.

In one embodiment a transceiver receives an encoded image sequence having a plurality of pictures. The transceiver will notify an upstream device of a detected event, e.g., an error or a missing frame. In response to the notification, a picture coded using a coded description optimized for the detected event, e.g. an I-picture type, is received at the transceiver.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a high level system view of a basic broadband network architecture in accordance with one embodiment of the present invention;

FIG. 2 is a system view in accordance with one embodiment of the present invention;

FIG. 3 is an illustration of how the number of I-pictures may be reduced in accordance with the present invention;

FIG. 4 illustrates a diagram in accordance with a method of the present invention;

FIG. 5 illustrates a diagram in accordance with a method of the present invention;

FIG. 6 illustrates a diagram in accordance with a method of the present invention; and

FIG. 7 illustrates an embodiment of a system in accordance with the present invention.

### DETAILED DESCRIPTION

The present invention provides a method and apparatus for multi-description video encoding that can be used to reduce the number of Intra-coded pictures (I-Frame or I-Picture) without any significant quality degradation. In one embodiment, the method takes advantage of characteristics of a heterogeneous network, such as Digital Subscription Line (DSL). Generally, there is a large amount of bandwidth from a video server to the Central Office (CO), however, a bottleneck may occur during the “last mile” of transmission, e.g., the access network. Additionally, in a DSL network, a channel change occurs in the CO, not in the home. Therefore, the inventive method codes each potential I-Picture (those used in conventional video compression) twice, once using I Picture type and one using P or B Picture type. Additionally, in another embodiment, each I Picture may be coded using both SI and SP Picture type. In the CO, if there is no channel change request received from a customer, or other similar conditions, no I-Picture is used. The I-Picture coded using P- or B- or SP-Picture type is instead used for transmission to home and other coded descriptions are dropped by DSLAM. If there is a channel change request, a picture coded using I-Picture type will be used instead of the picture coded using P-picture type (In SI/SP cased, the SI-Picture will be sent together with the SP-Picture). The inventive method and apparatus will not cause a delay that is more than what is now experienced by a customer.

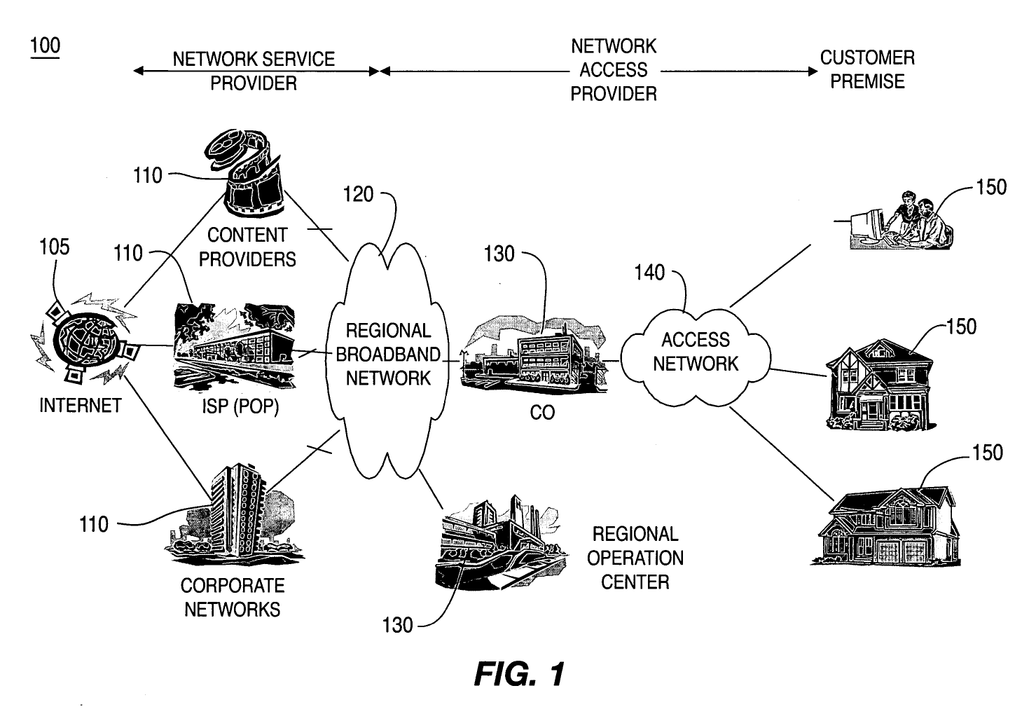

FIG. 1 illustrates one high level embodiment of a system in accordance with the present invention. Network service providers 110 may be connected to the internet 105 in order to send/receive information. Examples of network service providers include but are not limited to, content providers, internet service providers (ISP), corporate networks, and so on. Network service providers 110 may then be connected to network access providers 130 via a regional broadband network 120. Network access providers 130 (e.g., central office and regional operation center), are connected to customer premises 150 via an access network 140. Typically, the bandwidth on the regional broadband network 120 is very high. However, the bandwidth on the access network 140 is usually limited, thus creating a situation where there is a bottleneck condition due to the amount of information that must pass through the access network 140.

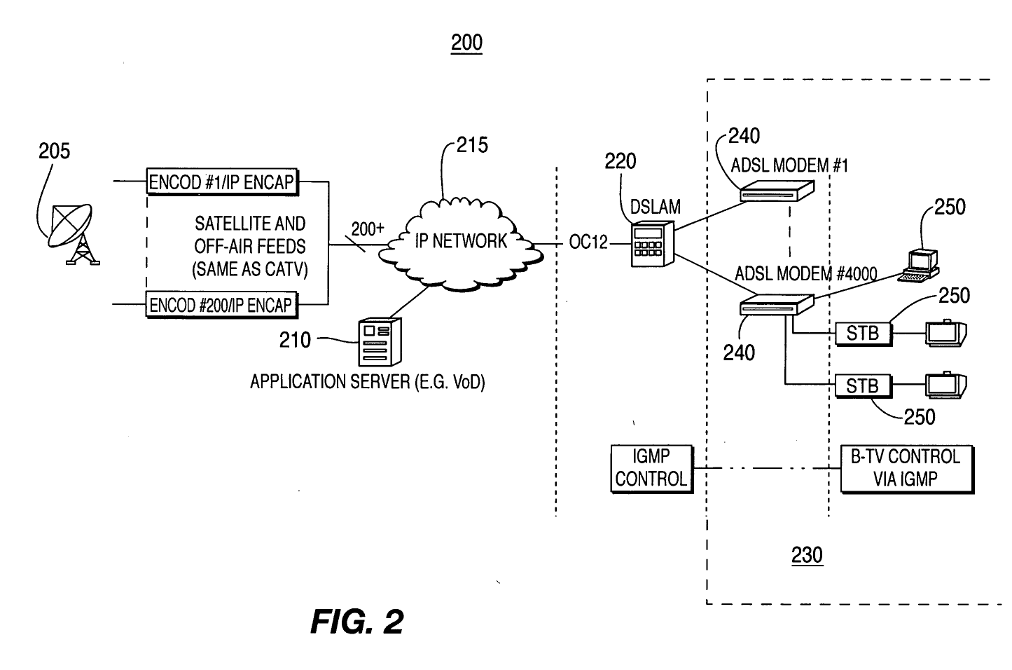

FIG. 2 illustrates an illustrative embodiment of a system in accordance with the present invention. A receiver 205 receives multiple image sequences and sends these image sequences to server 210, e.g., via network 215. Image sequences may also be received locally via camera or movie feed. The plurality of image sequences may be satellite and off-air feeds. Each of the plurality of image sequences may comprise multiple pictures.

If the image sequences are already encoded, these encoded streams can be forwarded directly to a router, e.g., DSLAM 220 via IP network 215. However, if the image sequences require encoding, they can be sent to server 210 where encoding is applied to the image sequences. Although DSLAM 220 may receive and act on a plurality of image sequences in accordance with the present invention, for simplicity, the disclosure will refer to one image sequence wherever possible. In one embodiment, server 210 encodes the plurality of image frames into a plurality of encoded frames in accordance with one embodiment of the present invention. Each image sequence is selectively encoded such that at least one of the plurality of pictures is encoded using at least two coded descriptions having different picture types. Depending on various encoding standards, e.g., MPEG, MPEG2, ATSC and the like, various frames in an image sequence will be identified to be encoded as I-Pictures. The decision for encoding a frame as an I-Frame may be responsive to a number of conditions, e.g., maximal delay allowed for a scene change, a requirement dictated by a standard, e.g., length of a GOP and so on. The present invention conforms with all encoding standards by generating I-Pictures (SI) as required, but it also generates an additional coded description (P or B Picture or SP) for each I-Picture. Namely, a picture is encoded using at least two coded descriptions having different picture types. The encoded pictures are then forwarded to a router 220. In one embodiment, the router 220 may be a Digital Subscriber Line Access Multiplexer (DSLAM). The router forwards the encoded frames to a modem 240. In one embodiment, the modem 240 may be an Asymmetric Digital Subscriber Line (ADSL) device. In turn, the modem 240 forwards the encoded pictures to an end user device 250. The end user device 250 may be a computer, set top box, or other device used in conjunction with an ADSL.

The DSLAM 220 receives the plurality of encoded image sequences. Each of the plurality of encoded image sequences comprises multiple pictures where at least one of the pictures is encoded using at least two coded descriptions having different picture types. For example, the DSLAM may receive an encoded image sequence having a plurality of GOPs where each GOP starts with an I-Picture. However, in accordance with the present invention, the I-Picture in each GOP is generally coded using at least two different picture types. The DSLAM 220 then forwards one or both of the two coded descriptions to a receiver 240 in accordance with a predefined event, e.g., receiving a channel change request.

In one embodiment, DSLAM 220 may receive I, P, SI, SP and B pictures. Depending on the type of compression used by the present invention, I, P, B, SI and SP pictures may be used. Some picture frames may be encoded as both an I-picture and a P-picture or as both SI-picture and SP-picture. The DSLAM will usually forward a P, B or SP picture, i.e., the picture type having the least amount of bits and automatically drops other descriptions of that picture. However, when a predefined event occurs, an I-picture or SI-picture plus the corresponding SP-picture will be forwarded instead. In other words, the DSLAM will usually send only a single I-Frame at the beginning of transmitting the image sequence to a user. Unless there is a channel change or scene change, only P, B or SP Pictures will be sent instead of their corresponding I-Pictures.

In one embodiment, the predefined event is a scene change. Only I-picture is sent in this instance. Hence, there is no multiple coded description for the potential I-picture assigned for a scene change.

In one embodiment, the predefined event is a channel change. When a channel change occurs, a customer or end user will send a channel change request from set top box 250 to DSLAM 220. Once DSLAM 220 receives the channel change request, an I-picture (or SI and SP) will be sent instead of any other picture types for a frame that starts in the next channel. Like a scene change, an I-picture must be sent since the temporal dependency capabilities of P-pictures and B-pictures cannot be exploited when a new image sequence is requested by a user. However, once an I-Picture is sent in the new channel, all subsequent I-Pictures can be replaced with other picture types, as available.

In one embodiment, the predefined event is an error correction action. When modem 240 detects errors or detects missing frame(s), an error recovery request is sent to DSLAM 220. DSLAM 220 will then send an I-Picture as the next picture in order to improve error resiliency.

To minimize the amount of computation needed by DSLAM 220, I-picture (except those I-pictures associated with scene changes) and SI-pictures can be assigned the lowest priority level and can be dropped as needed. SP-pictures are assigned the same priority level as P-pictures. SI and SP pictures are utilized to eliminate mismatches. These picture types can be used to improve error resiliency. The DSLAM will drop or transmit a description of a multi-described picture by only examining priority level associated with a video packet. A DSLAM or router can use this priority information to determine which description to use in an effective and efficient manner.

During a channel change, the first SI or I picture is transmitted since the buffer has just been flushed and there is nothing except SI or I to transmit. After the channel change, SI or I will be dropped if the bandwidth is tight. SI or I can be transmitted to improve error resiliency or as a refresh function if there exists enough bandwidth. SI or I can also be transmitted when a frame, such as P-picture is missing or dropped. It should be noted that although the present invention teaches the replacement of an I-Picture with other picture types, if the channel has capacity, the present invention can periodically send an I-frame to improve error resiliency or for refresh purpose.

DSLAM 220 may also receive information other than encoded image sequences from server 210. Traffic look ahead information may be sent to the DSLAM 220 in order to allow the DSLAM to properly allocate resources. The DSLAM will use this knowledge in order to be more aggressive or more conservative in picture type selection and/or packet-dropping during congestion. It should be noted that the information other than encoded images sequences received by DSLAM 220 can be individually packetized and forwarded to the DSLAM. For example, if the application server 210 detects changes in the encoded image sequence, it will send a message to the DSLAM that numerous scene changes will occur soon. This will alert the DSLAM to clear its buffer in anticipation that it will need to forward numerous I-Pictures to the user shortly. Alternatively, the look ahead information may indicate a lack of scene changes, where the DSLAM may elect to send I-Frames instead of P-Frames because of available bandwidth.

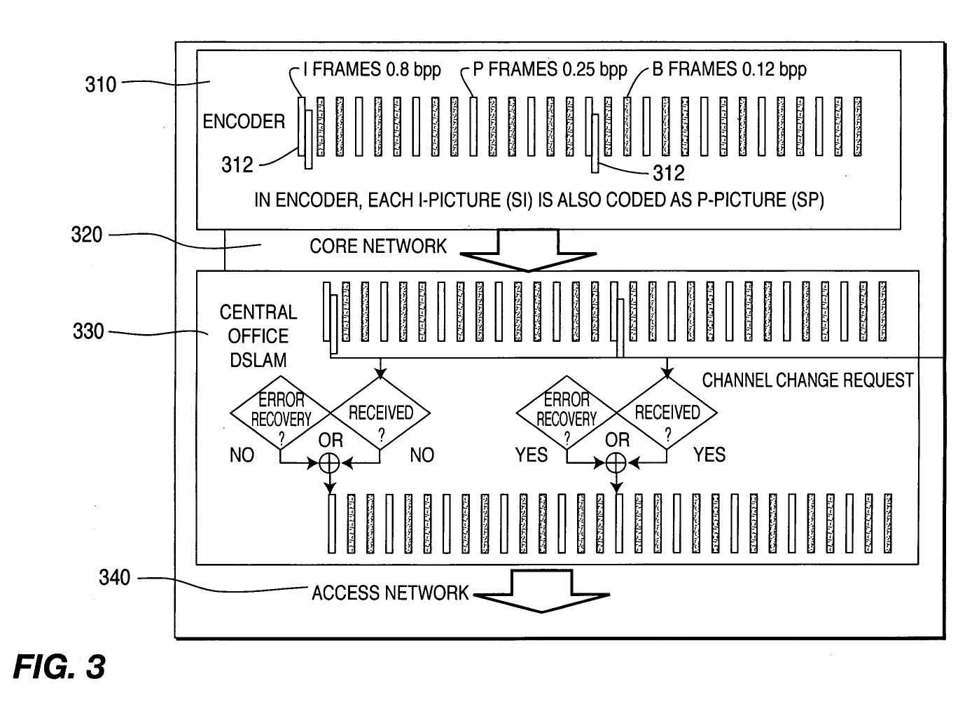

FIG. 3 illustrates how a channel change or error recovery request may be accomplished according to one embodiment of the invention. An encoder 310 encodes an image sequence in accordance with the novel method as described above. Certain frames 312 are encoded as both I-Picture and P-Picture or SI-Picture and SP-Picture. The encoded image sequence is forwarded through the core network 320 to the DSLAM 330. The DSLAM 330 then forwards the encoded image sequence through the access network 340 to the customer premise (not shown) after selecting which picture type to send where there is an option to do so. Thus, frame 312 is actually encoded using two different picture types. In turn, the DSLAM has the ability to detect a predefined event to selectively send only one of these two picture types to the user.

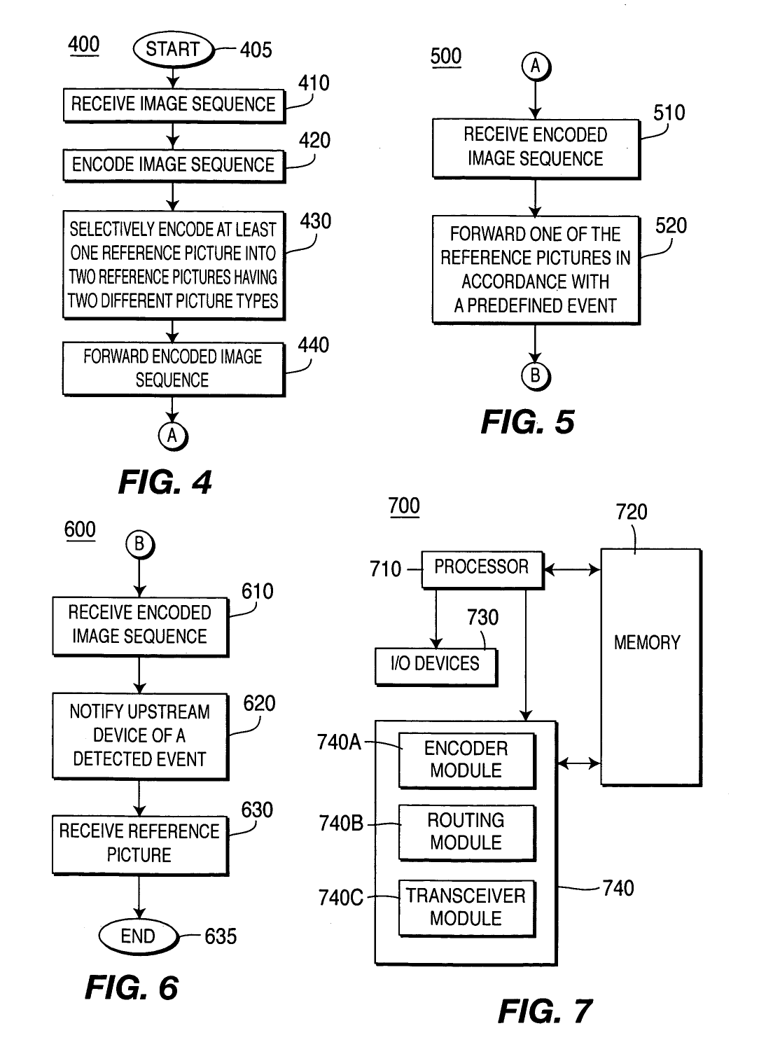

FIG. 4 illustrates a diagram in accordance with a method 400 of the present invention. Method 400 starts in step 405 and proceeds to step 410. In step 410 an image sequence is received, e.g., from receiver 205. In step 420 the image sequence is encoded by an encoder, e.g., located at server 210. In step 430 at least one picture, e.g., an I-Picture is selectively encoded using as at least two coded descriptions having different picture types, e.g., an I-Picture and a P-Picture or an SI-Picture and an SP-Picture. In step 440 the encoded image sequence is forwarded from server 210 to a router, e.g., a DSLAM 220.

FIG. 5 illustrates a diagram in accordance with a method 500 of the present invention. Method 500 begins in step A and proceeds to step 510. In step 510 an encoded image sequence is received at DSLAM 220. In step 520 one of the at least two coded descriptions encoded at step 430 is forwarded with the encoded image sequence in accordance with a predefined event. This predefined event may be predicated on information received from the server 210 or may occur as a result of information received from modem 240.

FIG. 6 illustrates a diagram in accordance with a method 600 of the present invention. Method 600 begins in step B and proceeds to step 610. In step 610 an encoded image sequence is received by modem 240. In step 620 modem 240 notifies an upstream device, i.e., DSLAM 220, of a detected event, e.g., an error condition or a missing frame condition. In step 630 a coded description of a picture optimized for the detected event, e.g., an I-Picture instead of a P-Picture, is received by modem 240 from DSLAM 220. Method 600 ends in step 635.

FIG. 7 illustrates a block diagram of an image processing device or system 700 of the present invention. Specifically, the system can be employed to reduce the number of Intra-coded pictures (I-Picture, or SI-Picture) without any significant quality degradation. In one embodiment, the image processing device or system 700 is implemented using a general purpose computer or any other hardware equivalents.

Thus, image processing device or system 700 comprises a processor (CPU) 710, a memory 720, e.g., random access memory (RAM) and/or read only memory (ROM), an encoder module 740A, a routing module 740B, a transceiver module 740C, and various input/output devices 730, (e.g., storage devices, including but not limited to, a tape drive, a floppy drive, a hard disk drive or a compact disk drive, a receiver, a transmitter, a speaker, a display, an image capturing sensor, e.g., those used in a digital still camera or digital video camera, a clock, an output port, a user input device (such as a keyboard, a keypad, a mouse, and the like, or a microphone for capturing speech commands).

It should be understood that the encoder module 740A, routing module 740B, and transceiver module 740C can be implemented as one or more physical devices that are coupled to the CPU 710 through a communication channel. Alternatively, the encoder module 740A, routing module 740B, and transceiver module 740C can be represented by one or more software applications (or even a combination of software and hardware, e.g., using application specific integrated circuits (ASIC)), where the software is loaded from a storage medium, (e.g., a magnetic or optical drive or diskette) and operated by the CPU in the memory 720 of the computer. As such, the encoder module 740A, routing module 740B, and transceiver module 740C (including associated data structures) of the present invention can be stored on a computer readable medium, e.g., RAM memory, magnetic or optical drive or diskette and the like.

By utilizing the present invention, in one embodiment, the I-picture type will only be selected for the final transmission to home when a channel change request is received at the central office. Therefore, there is a reduction in the minimal number of I-Pictures from one per second or one per half second to one per channel change request.

Additionally, since pictures coded using I-picture type are used when a channel change request is received. More multi-description coding of I-pictures can be using without increasing the actual bandwidth transmitted over a DSL. Therefore, small GOP size can be used to reduce channel change delay without increasing the bit rate for the ADSL delivery.

Finally, some of the pictures can be coded at different bit rates, e.g. some bit rates can be much lower than what will be used in normal encoding. This would be done in order to facilitate channel change or other applications.

While the foregoing is directed to embodiments of the present invention, other and further embodiments of the invention may be devised without departing from the basic scope thereof.

1. A method for processing an encoded image sequence having a plurality of encoded pictures, comprising:
receiving the encoded image sequence where at least one of said plurality of encoded pictures is encoded using at least two coded descriptions having different picture types; and
forwarding at least one of said at least two coded descriptions with said encoded image sequence to a receiver.

2. The method of claim 1, wherein said forwarding is adjusted in accordance with a predefined event comprising a channel change request.

3. The method of claim 1, wherein said forwarding is adjusted in accordance with a predefined event comprising an error correction request.

4. The method of claim 1, further comprising receiving look ahead information to allow proper allocation of resources.

5. The method of claim 1, wherein said at least two coded descriptions comprise I and P Pictures.

6. The method of claim 5, wherein said or I Pictures and P Pictures are coded at multiple bit rates, multiple resolutions or using multiple coding methods.

7. The method of claim 1, wherein said at least two coded descriptions comprise SI and SP Pictures.

8. The method of claim 7, wherein said SI and SP Pictures are coded at multiple bit rates, multiple resolutions or using multiple coding methods.

9. The method of claim 1, wherein priority information is used to determine which of said at least two coded descriptions is forwarded to said receiver.

10. A method for encoding an image sequence, comprising:
receiving the image sequence having a plurality of pictures; and
selectively encoding at least one of said plurality of pictures as at least two coded descriptions having different picture types.

11. The method of claim 10, wherein priority information is assigned to each of said at least two coded descriptions.

12. The method of claim 10, further comprising forwarding the encoded image sequence with the at least two coded descriptions.

13. A method for processing an image sequence, comprising:
receiving an encoded image sequence having a plurality of pictures;
notifying an upstream device of a detected event; and
receiving a coded description of a picture optimized for the detected event.

14. The method of claim 13, wherein said detected event comprises a channel change request.

15. The method of claim 13, wherein said detected event comprises an error condition.

16. The method of claim 13, wherein said upstream device is a Digital Subscriber Line Access Multiplexer (DSLAM).

17. The method of claim 13, wherein said coded description comprises an I-picture.

18. The method of claim 13, wherein said coded description comprises an SI-picture.

19. A computer-readable medium having stored thereon a plurality of instructions, the plurality of instructions including instructions which, when executed by a processor, cause the processor to perform the steps of a method for processing an encoded image sequence having a plurality of encoded pictures, comprising:
receiving the encoded image sequence where at least one of said plurality of encoded pictures is encoded using at least two coded descriptions having different picture types; and
forwarding at least one of said at least two coded descriptions with said encoded image sequence to a receiver.

20. A computer-readable medium having stored thereon a plurality of instructions, the plurality of instructions including instructions which, when executed by a processor, cause the processor to perform the steps of a method for encoding an image sequence, comprising:
receiving the image sequence having a plurality of pictures; and
selectively encoding at least one of said plurality of pictures as at least two coded descriptions having different picture types.

21. A computer-readable medium having stored thereon a plurality of instructions, the plurality of instructions including instructions which, when executed by a processor, cause the processor to perform the steps of a method for processing an image sequence, comprising:
receiving an encoded image sequence having a plurality of pictures;
notifying an upstream device of a detected event; and
receiving a coded description of a picture optimized for the detected event.

22. An apparatus for processing an encoded image sequence having a plurality of encoded pictures, comprising:
means for receiving the encoded image sequence where at least one of said plurality of encoded pictures is encoded using at least two coded descriptions having different picture types; and
means for forwarding at least one of said at least two coded descriptions with said encoded image sequence to a receiver.

23. An apparatus for encoding an image sequence, comprising:
means for receiving the image sequence having a plurality of pictures; and
means for selectively encoding at least one of said plurality of pictures as at least two coded descriptions having different picture types.

24. An apparatus for processing an image sequence, comprising:
means for receiving an encoded image sequence having a plurality of pictures;
means for notifying an upstream device of a detected event; and
means for receiving a coded description of a picture optimized for the detected event.
